(19) United States
(12) Patent Application Publication
(10) Pub. No.: US 2025/0333912 A1
(43) Pub. Date: Oct. 30, 2025

(54) Bracket Device for Tree Pit Root Management

(71) Applicant: Greenpros Company Limited, Taipei City (TW)

(72) Inventor: Yee-Hsian Li, New Taipei City (TW)

(21) Appl. No.: 18/754,133

(22) Filed: Jun. 25, 2024

(30) Foreign Application Priority Data
Apr. 30, 2024 (TW) 113116169

(51) Int. Cl. E01C 9/00; A01G 13/02

(52) U.S. Cl. CPC E01C 9/005; A01G 13/27

(57) ABSTRACT

A bracket device for tree pit root management is provided, including at least three hexagonal bracket elements and a cover; wherein each hexagonal bracket element includes a center bracket, six side brackets, and six connecting brackets, a corner is formed between two adjacent side brackets, and an arc-shaped groove is formed at the top of each corner. The arc length of the top arc-shaped groove is one-third of the circumference of a circle. The connecting brackets connect the center bracket and the side brackets respectively. When three corners of the hexagonal bracket elements are connected, the top arc-shaped grooves of the three corners are connected to form a top circular groove. The cover comprises a convex ring inserted into the top circular groove. The bracket module formed by connecting multiple bracket devices supported by the columns to provide the overall structural strength and soil-supporting effect are better.

### CROSS-REFERENCE TO RELATED APPLICATION

This application claims the priority of Taiwanese patent application No. 113116169, filed on Apr. 30, 2024, which is incorporated herewith by reference.

### BACKGROUND OF THE INVENTION

### 1. Field of the Invention

The present invention relates generally to a bracket device, and more particularly, to a bracket device for tree pit root management.

### 2. The Prior Arts

Street trees refer to trees planted on both sides of urban roads or around sidewalks. These trees are often used for purposes such as decorating urban environments, providing shade, purifying the air, improving climate and greening the environment. Therefore, it is very important to maintain the root system of street trees.

The current practice is to dig a tree pit in the tree planting area, the adjacent driveway or the hard pavement, and install a plurality of bracket modules in the tree pit. Each bracket module comprises a plurality of bracket devices, and we can plant trees in the center hole formed by the bracket modules, then backfilling the soil into the modules, and finally covering up the surface of the planting area to restore hard pavement for people and vehicles to pass. The root system is protected from soil compaction due to heavy pressure on the pavement. The above practice is common in the developed countries. It effectively expands the underground good soil volume of street trees while keeps sidewalks and driveways clear for pedestrians and vehicles.

However, the existing bracket modules are all in rectangular shapes, the bracket modules are either stand alone or bridged by a short panel. The bracket system formed by modules is also rectangular which is different from the common round shape of the root balls. It causes waste of materials and reduce growth area for the roots.

### SUMMARY OF THE INVENTION

A primary objective of the present invention is to provide a bracket device for tree pit root management, which is better jointed to improve stability and the hexagonal shape has better overall structural strength and will form a quasi-round shape to allow roots to grow better.

In order to achieve the aforementioned objective, the present invention provides a bracket device for tree pit root management, including at least three hexagonal bracket elements and a cover. Each hexagonal bracket element includes a center bracket, six side brackets, and six connecting brackets. A corner is formed between two adjacent side brackets, and an arc-shaped groove is formed at the top of each corner. The arc length of the top arc-shaped groove is one-third of the circumference of a circle. The connecting brackets connect the center bracket and the side brackets respectively. When three corners of the hexagonal bracket elements are connected, the top arc-shaped grooves of the three corners are connected to form a top circular groove. The cover comprises a convex ring, and the convex ring is inserted into the top circular groove to fortify the strength of the circular grooves.

Furthermore, connecting a top bracket device and a bottom bracket device by a column at the top circular groove and the bottom circular groove will fortify the joint and create a space for soil infill to form a bracket module. Surrounding a center with a plurality of bracket modules will create a quasi-circular shape of a bracket system.

The advantage of the present invention is that the bracket devices formed by hexagonal bracket elements are more stable than the rectangular module and can be combined indefinitely into a nearly circular bracket system. The cover can fix the hexagonal bracket devices to each other, and the bracket module formed by using the columns to connect the top and bottom bracket devices can provide an infill space for soil. The overall structural strength of the hexagonal module is better to protect soil from compaction than the rectangular shape. The quasi-round shape of the system is more suitable for the roots in the round-shaped root ball to grow.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of the bracket device of the present invention.

FIG. 2 is an exploded view of the bracket device of the present invention.

FIG. 3 is a cross-sectional view along line III-III in FIG. 1.

FIG. 4 is a perspective view of the first embodiment of the hexagonal bracket element of the present invention.

FIG. 5 is a top view of the first embodiment of the hexagonal bracket element of the present invention.

FIG. 6 is a bottom view of the first embodiment of the hexagonal bracket element of the present invention.

FIG. 7 is a perspective view of the first embodiment of the first corner complete element of the present invention.

FIG. 8 is a top view of the first embodiment of the first corner complete element of the present invention.

FIG. 9 is a bottom view of the first embodiment of the first corner complete element of the present invention.

FIG. 10 is a perspective view of the first embodiment of the second corner complete element of the present invention.

FIG. 11 is a top view of the first embodiment of the second corner complete element of the present invention.

FIG. 12 is a bottom view of the first embodiment of the second corner complete element of the present invention.

FIG. 13 is a schematic view of a root ball passing through the bracket device of the present invention.

FIG. 14 is a perspective view of the first bracket module of the present invention.

FIG. 15 is an exploded view of the first bracket module of the present invention.

FIG. 16 is a cross-sectional view along line XVI-XVI in FIG. 14.

FIG. 17 is a schematic view of a root ball passing through the first embodiment of the bracket system of the present invention.

FIG. 18 is a perspective view of the second bracket module of the present invention.

FIG. 19 is an exploded view of the second bracket module of the present invention.

FIG. 20 is a cross-sectional view along line XX-XX in FIG. 18.

FIG. 21 is a perspective view of the second embodiment of the hexagonal bracket element of the present invention.

FIG. 22 is a top view of the second embodiment of the hexagonal bracket element of the present invention.

FIG. 23 is a bottom view of the second embodiment of the hexagonal bracket element of the present invention.

FIG. 24 is a perspective view of the second embodiment of the first corner complete element of the present invention.

FIG. 25 is a top view of the second embodiment of the first corner complete element of the present invention.

FIG. 26 is a bottom view of the second embodiment of the first corner complete element of the present invention.

FIG. 27 is a perspective view of a second embodiment of the second corner complete element of the present invention.

FIG. 28 is a top view of the second embodiment of the second corner complete element of the present invention.

FIG. 29 is a bottom view of the second embodiment of the second corner complete element of the present invention.

FIG. 30 is a schematic view of a root ball passing through the second embodiment of the bracket system of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

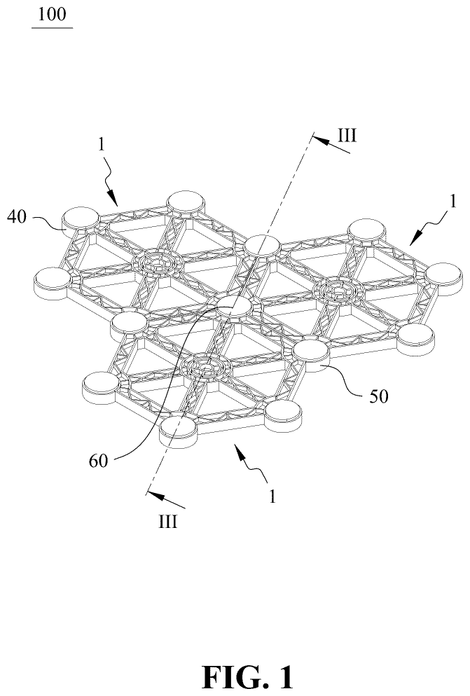

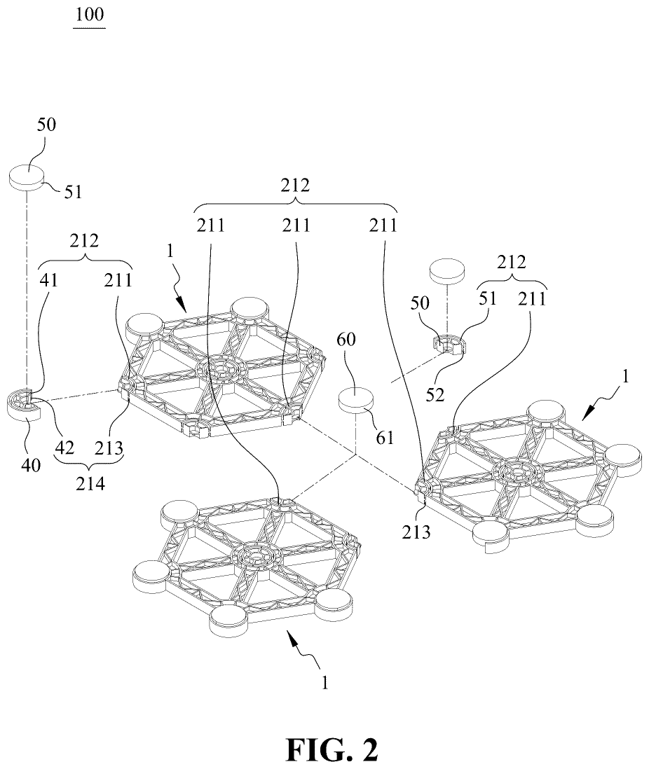

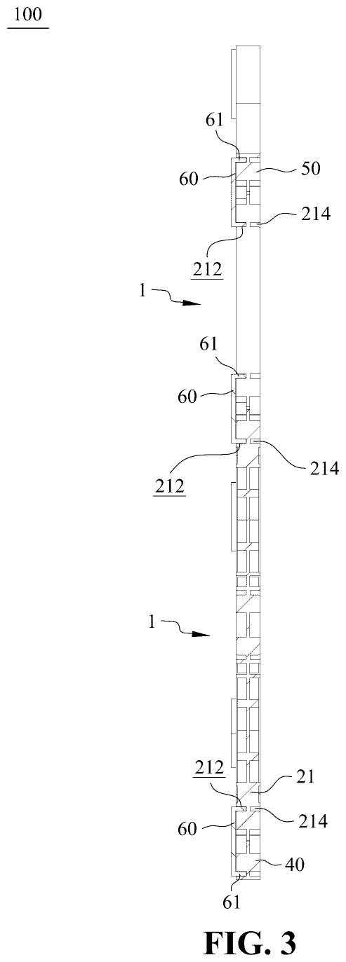

As shown in FIGS. 1, 2 and 3, the present invention provides a bracket device 100 for tree pit root management, including three hexagonal bracket elements 1, a plurality of first corner complete elements 40, a plurality of a second corner complete element 50, and a plurality of covers 60.

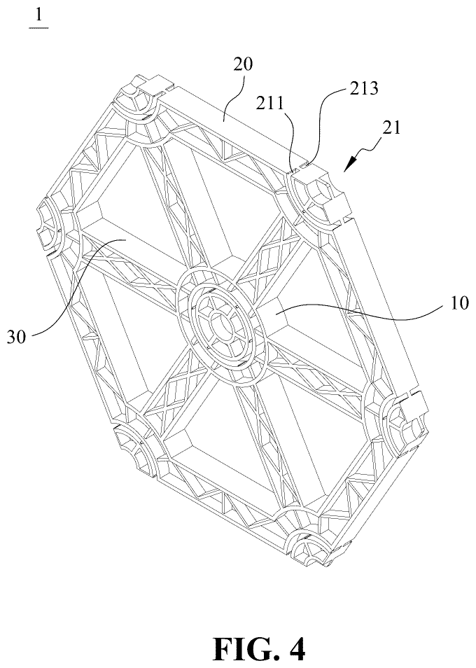

As shown in FIGS. 4, 5 and 6, each hexagonal bracket element 1 includes a central bracket 10, six side brackets 20, and six connecting brackets 30. A corner 21 is formed between two adjacent side brackets 20. The top of each corner 21 forms a top arc-shaped groove 211. The arc length of the top arc-shaped groove 211 of each corner 21 is one-third of the circumference of a circle. The connecting brackets 30 connect the center bracket 10 and the side brackets 20, respectively. As shown in FIGS. 1, 2 and 3, when the three corners 21 of the hexagonal bracket element 1 are butted together, the top arc-shaped grooves 211 of the corners 21 form a top circular groove 212.

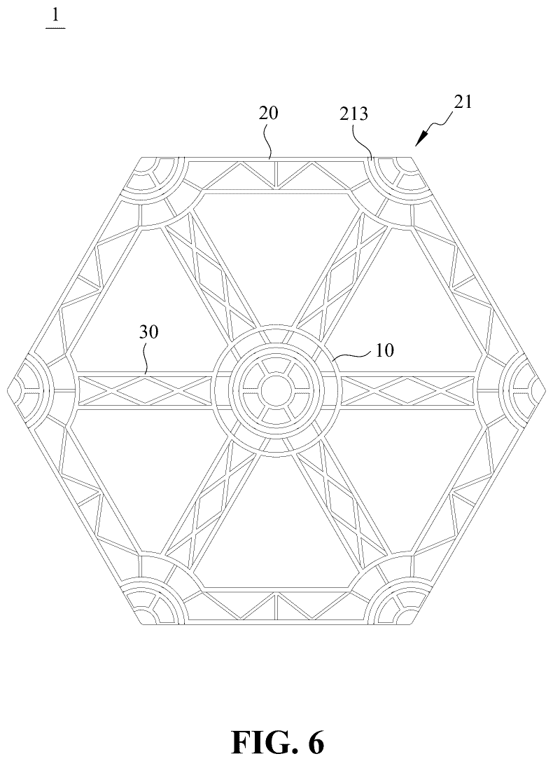

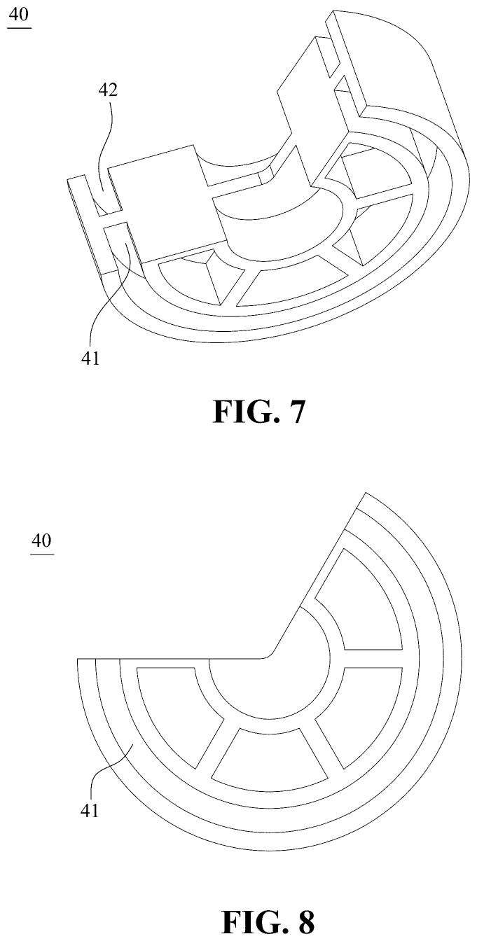

As shown in FIGS. 7, 8 and 9, a top arc-shaped groove 41 is formed on the top of each first corner complete element 40, and the arc length of the top arc-shaped groove 41 of each first corner complete element 40 is two-thirds of the circumference of a circle. As shown in FIGS. 1, 2 and 3, when each first corner complete element 40 butts with each corner 21, the top arc-shaped groove 41 of each first corner complete element 40 and the top arc-shaped groove 211 of each corner 21 form a top circular groove 212. Preferably, each first corner complete element 40 has a structure of a two-thirds circular.

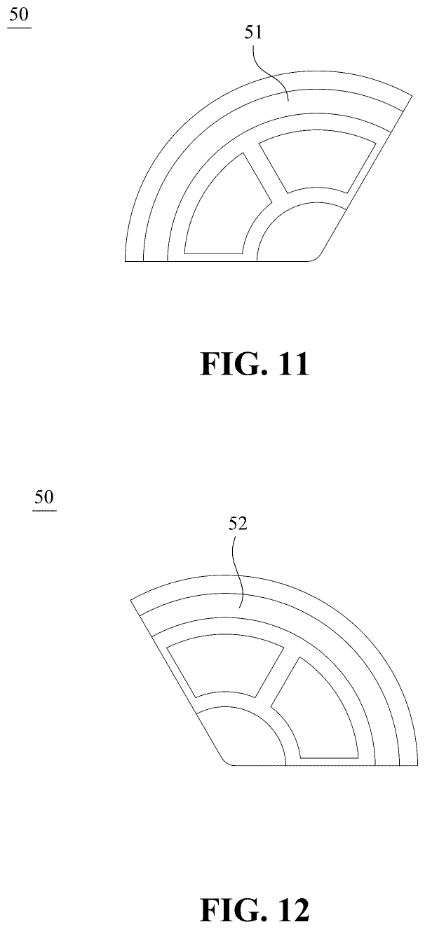

As shown in FIGS. 10, 11 and 12, the top of each second corner complete element 50 forms a top arc-shaped groove 51, and the arc length of the top arc-shaped groove 51 of each second corner complete element 50 is one-third of the circumference of a circle. As shown in FIGS. 1, 2 and 3, when each second corner complete element 50 butts with the two corners 21, the top arc-shaped groove 51 of each second corner complete element 50 and the top arc-shaped groove 211 of the two corners 21 form a top circular groove 212. Preferably, each second corner complete element 50 has a structure of a one-third circular.

As shown in FIGS. 1, 2 and 3, each cover 60 has a convex ring 61, and the convex rings 61 of the covers 60 are respectively inserted into the top circular grooves 212.

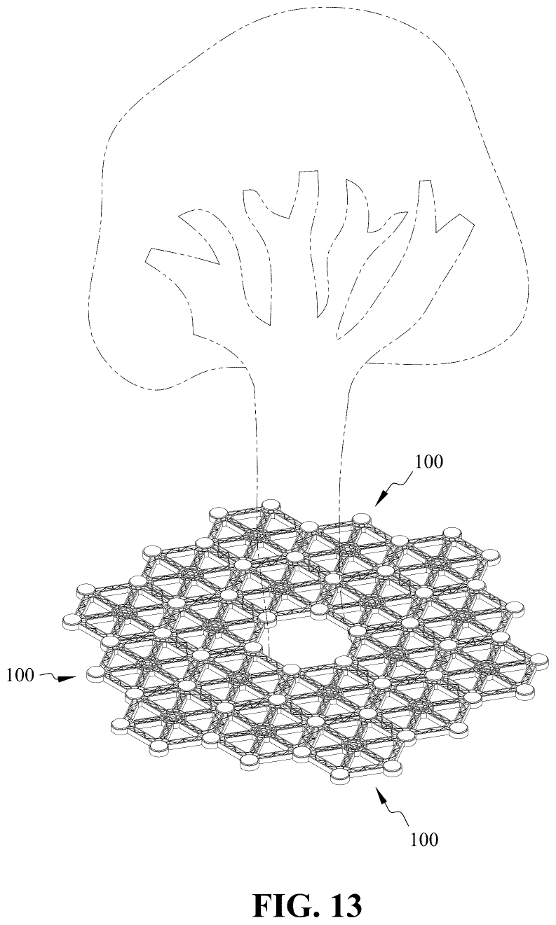

As shown in FIGS. 13, a plurality of bracket devices 100 are arranged around the same plane and together form a central hole. The central hole is used for a root ball to pass through.

Specifically, during construction, a tree pit is dug in the tree planting area, the adjacent driveway or the hard pavement, and the bracket devices 100 are installed in the tree pit. A drainage system (not shown in the figure) can be installed in the space formed by the hexagonal bracket elements 1, a root ball is planted in the center hole formed by the bracket devices, then backfilling the soil into the tree pits, and finally covering up the surface of the planting area to restore hard pavement for people and vehicles to pass.

As such, the hexagonal bracket elements 1 are more stable than the rectangular shape and can be combined indefinitely into a nearly circular bracket device 100, and the cover 60 can fix the hexagonal bracket elements 1 to one another to increase the system stability. The overall structural strength is better to protect soil from compaction and the quasi-round shape is more suitable for the roots in the root ball to grow.

Furthermore, the first corner complete elements 40 and the second corner complete elements 50 can reinforce the structural strength of the corners 21 of the hexagonal bracket element 1, and the covers 60 can fix the first corner complete elements 40, the second corner complete elements 50, and the hexagonal bracket elements 1 to each other, so that the overall structural strength is better and the effect of supporting soil is better.

Preferably, as shown in FIGS. 4, 5 and 6, the connecting brackets 30 connect the corners 21 of the center bracket 10 and the side brackets 20 respectively. Therefore, the connection positions of the connecting brackets 30 help to strengthen the overall structural strength of the hexagonal bracket element 1.

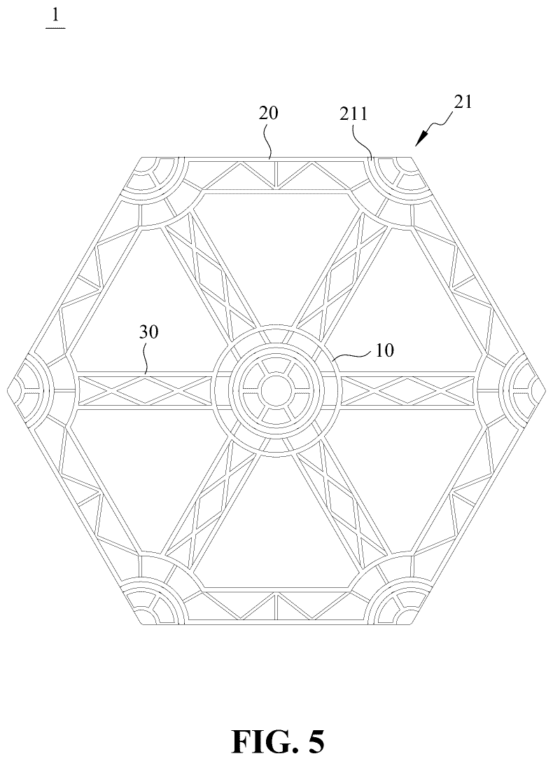

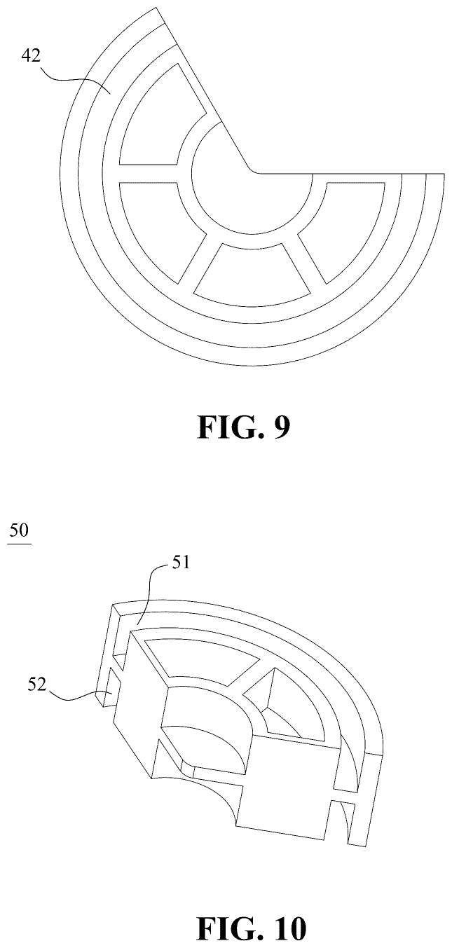

Preferably, as shown in FIGS. 4 and 6, a bottom arc-shaped groove 213 is formed at the bottom of each corner 21, and the arc length of the bottom arc-shaped groove 213 of each corner 21 is one-third of the circumference of a circle. As shown in FIGS. 1, 2 and 3, when the three corners 21 of the hexagonal bracket element 1 are butted together, the bottom arc-shaped grooves 213 of the corners 21 form a bottom circular groove 214. As shown in FIGS. 7 and 9, a bottom arc-shaped groove 42 is formed at the bottom of each first corner complete element 40, and the arc length of the bottom arc-shaped groove 42 of each first corner complete element 40 is two-thirds of the circumference. As shown in FIGS. 10 and 12, a bottom arc-shaped groove 52 is formed at the bottom of each second corner complete element 50, and the arc length of the bottom arc-shaped groove 52 of each second corner complete element 50 is two-thirds of the circumference of a circle. As shown in FIGS. 1, 2 and 3, when each first corner complete element 40 butts with each corner 21, the bottom arc-shaped groove 42 of each first corner complete element 40 and the bottom arc-shaped groove 213 of each corner 21 form a bottom circular groove 214; when each second corner complete element 50 butts with the two corners 21, the bottom arc-shaped groove 52 of each second corner complete element 50 and the bottom arc-shaped grooves 213 of the two corners 21 form a bottom circular groove (not shown in the figure).

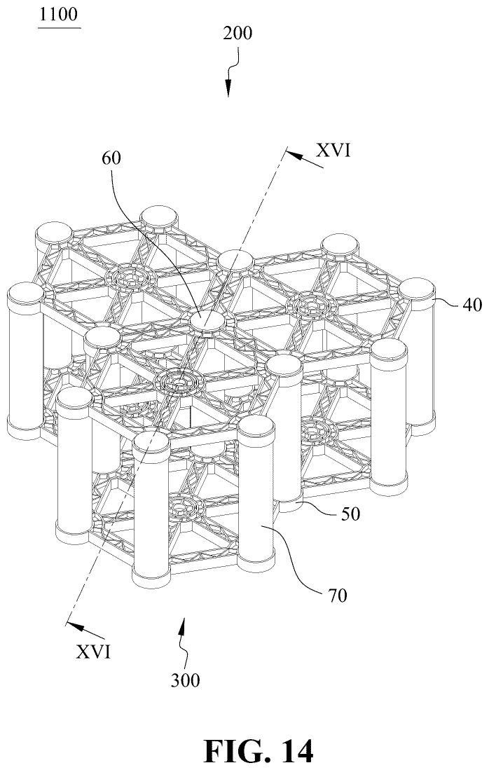

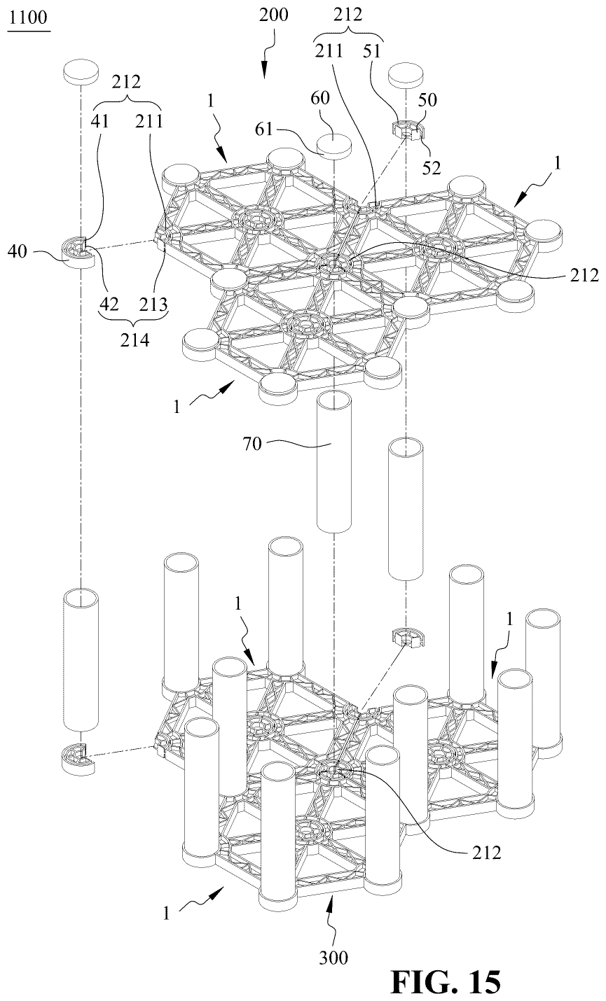

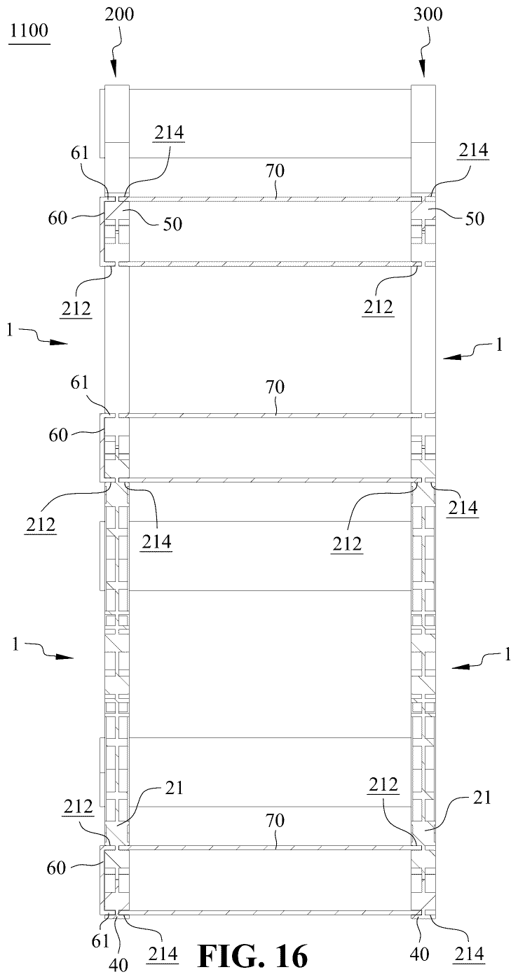

As shown in FIGS. 14, 15 and 16, two bracket devices 200, 300 and a column 70 form a first bracket module 1100. The bracket devices 200 and 300 are respectively defined as a top bracket device 200 and a bottom bracket device 300. A first end of the column 70 is inserted into the bottom circular grooves 214 of the top bracket device 200, and a second end of the column 70 is inserted into the top circular groove 212 of the bottom bracket device 300. A plurality of first bracket modules 1100 form a first embodiment of the bracket system 1000.

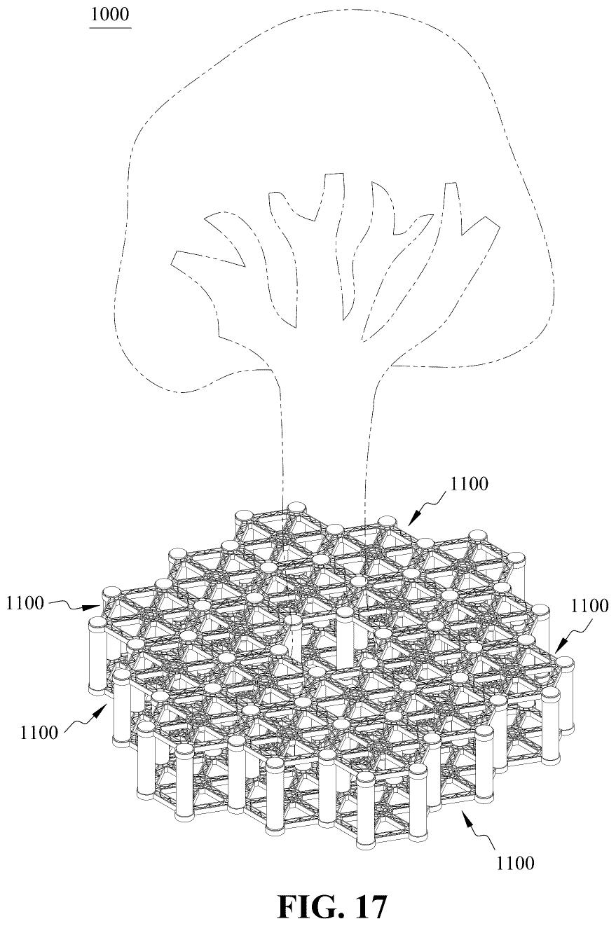

As shown in FIG. 17, the plurality of top bracket devices 200 are arranged around the same plane and jointly form a first center hole. The plurality of bottom bracket devices 300 are arranged around the same plane and jointly form a second center hole. The first center hole and the second center hole are aligned and are used for a root ball to pass through.

Specifically, during construction, a tree pit is dug in the tree planting area, the adjacent driveway or the hard pavement, and the first embodiment of the bracket system 1000 is installed in the tree pit. A drain system (not shown) can be installed in the space formed by the hexagonal bracket elements 1, planting a root ball in the first center hole formed by the bracket devices, then backfilling the soil into the tree pits, and finally covering up the surface of the planting area to restore hard pavement for people and vehicles to pass.

Compared with three bracket devices 100, through the serial connection and support of the columns 70, the first embodiment of the bracket system 1000 provides better overall structural strength and the effect of supporting the soil is better.

Furthermore, through the serial connection and support of the columns 70, the second embodiment of the bracket system 1000A can create a deeper and wider tree pit, and can provide a deeper and wider growth space for the tree's root system.

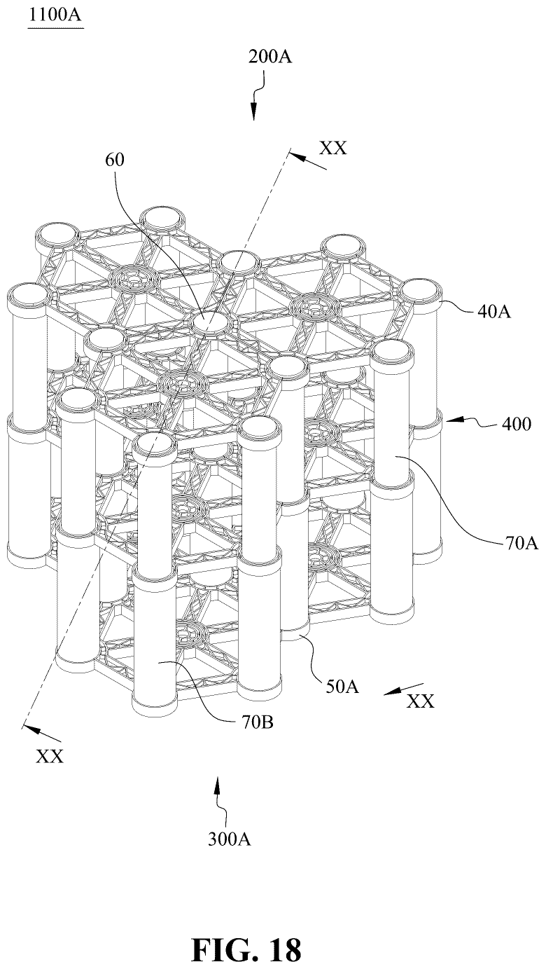

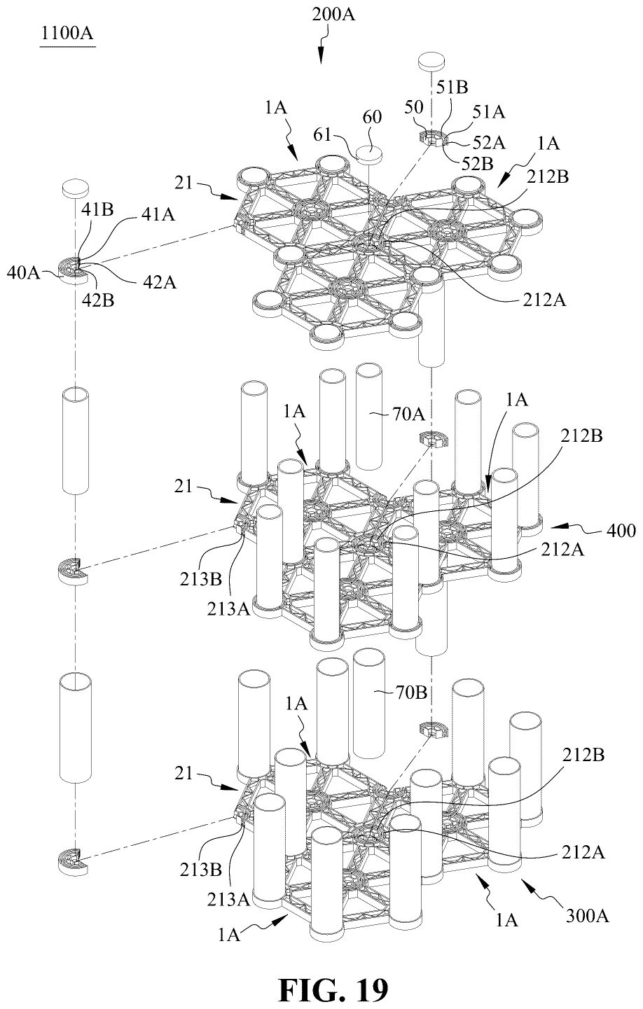

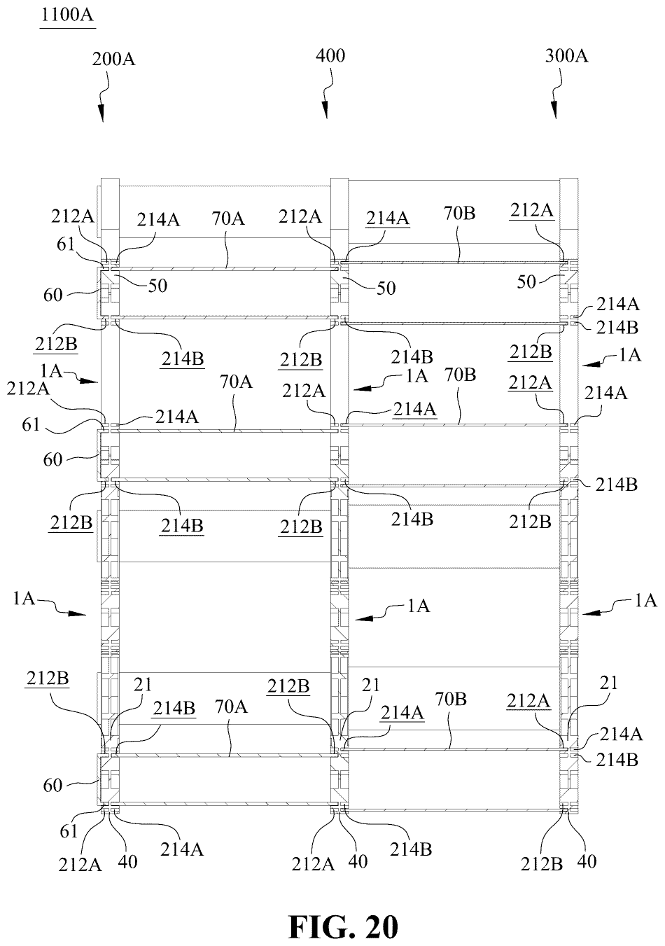

As shown in FIGS. 18, 19 and 20, the three bracket devices 200A, 300A, 400 a plurality of first columns 70A, and a plurality of second columns 70B form a second bracket module 1100A. The plurality of bracket devices are respectively defined as a top bracket device 200A, a middle bracket device 400, and a bottom bracket device 300A. Each of the top bracket device 200A, the middle bracket device 400 and the bottom bracket device 300A includes three hexagonal bracket elements 1A, a plurality of first corner complete elements 40A, a plurality of second corner complete elements 50A, and a plurality of covers 60. A plurality of second bracket modules 1100A form a second embodiment of the bracket system 1000A of the present invention.

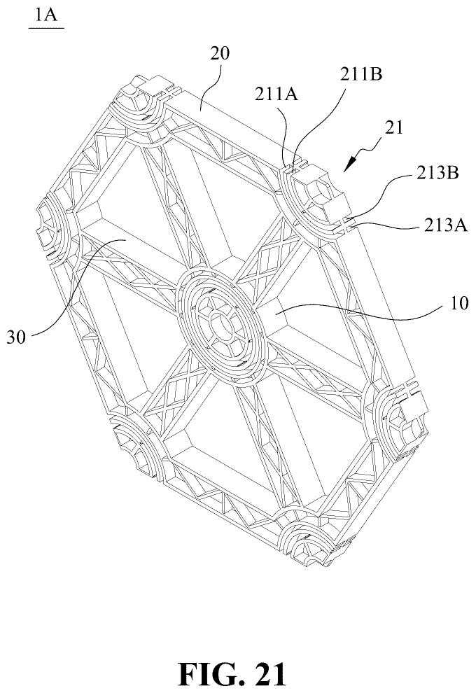

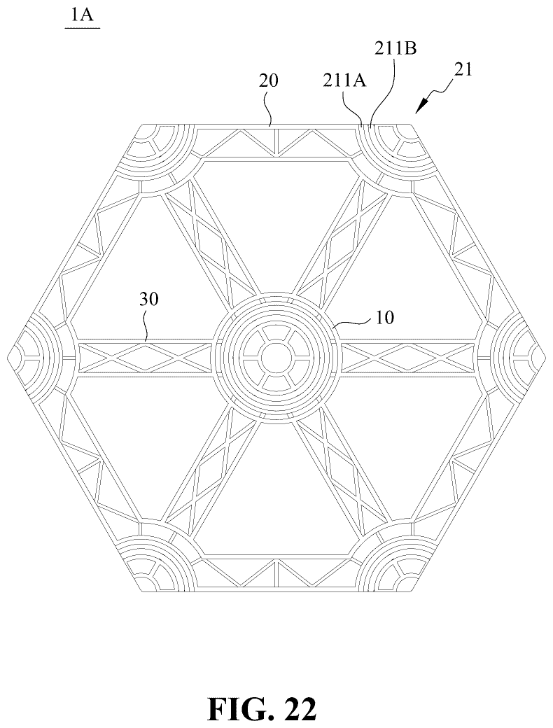

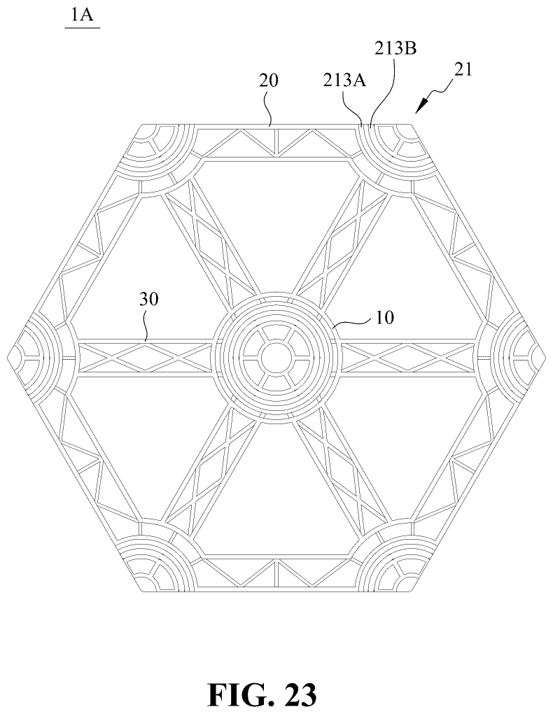

As shown in FIGS. 21, 22 and 23, the difference between the hexagonal bracket element 1A and the hexagonal bracket element 1 is that: first, the top of each corner 21 forms a first top arc-shaped groove 211A and a second top arc-shaped groove 211B, the first top arc-shaped groove 211A of each corner 21 is located on outer side the second top arc-shaped groove 211B of each corner 21, the arc length of the first top arc-shaped groove 211A of each corner 21 is one-third of the circumference of a circle, and the arc length of the second top arc-shaped groove 211B of each corner 21 is one-third of the circumference of a circle; second, the bottom of each corner 21 forms a first bottom arc-shaped groove 213A and a second bottom arc-shaped groove 213B, the first bottom arc-shaped groove 213A of each corner 21 is located on outer side the second bottom arc-shaped groove 213B of each corner 21, the arc length of the first bottom arc-shaped groove 213A of each corner 21 is one-third of the circumference of a circle, and the arc length of the second bottom arc-shaped groove 213B of each corner 21 is one-third of the circumference of a circle. As shown in FIGS. 18, 19 and 20, when the three corners 21 of three hexagonal bracket elements 1A are butted together, the first top arc-shaped grooves 211A of the corners 21 form a first top circular groove 212A, the second top arc-shaped grooves 211B of the corners 21 form a second top circular groove 212B, the first bottom arc-shaped grooves 213A of the corners 21 form a first bottom circular groove 214A, and the second bottom arc-shaped grooves 213B of the corners 21 form a second bottom circular groove 214B.

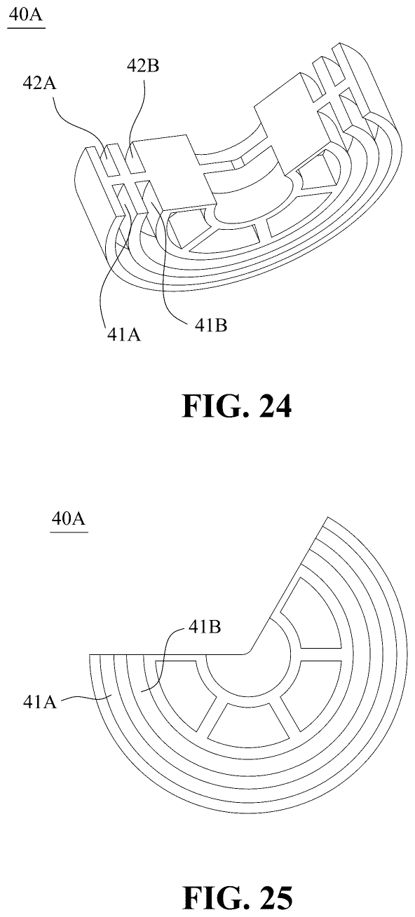

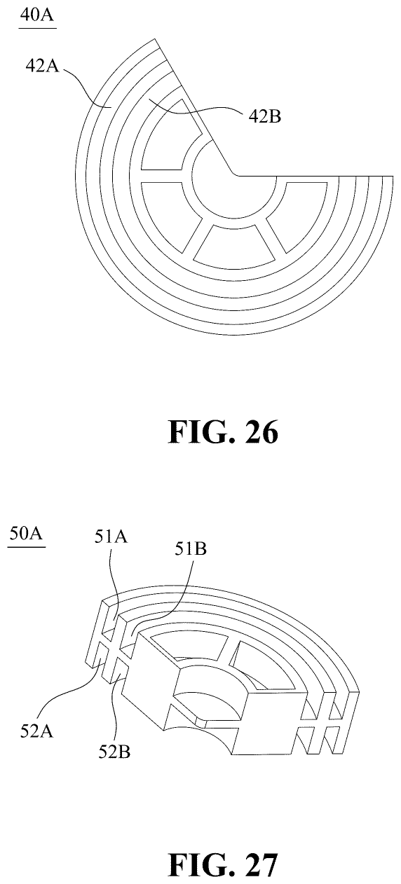

As shown in FIGS. 24, 25 and 26, the difference between the first corner complete element 40A and the first corner complete element 40 is that: first, the top of each first corner complete element 40A forms a first top arc-shaped groove 41A and a second top arc-shaped groove 41B, the first top arc-shaped groove 41A of each first corner complete element 40A is located on outer side the second top arc-shaped groove 41B of each first corner complete element 40A, the arc length of the first top arc-shaped groove 41A of each first corner complete element 40A is two-thirds of the circumference, and the arc length of the second top arc-shaped groove 41B of each first corner complete element 40A is three-thirds of the circumference of a circle; second, the bottom of each first corner complete element 40A forms a first bottom arc-shaped groove 42A and a second bottom arc-shaped groove 42B; the first bottom arc-shaped groove 42A of each first corner complete element 40A is located on outer side the second bottom arc-shaped groove 42B of each first corner complete element 40A, the arc length of the first bottom arc-shaped groove 42A of each first corner complete element 40A is two-thirds of the circumference of a circle, and the arc length of the second bottom arc-shaped groove 42B of each first corner complete element 40A is two-thirds of the circumference of a circle. As shown in FIGS. 18, 19 and 20, when each first corner complete element 40A butts with each corner 21, the first top arc-shaped groove 41A of each first corner complete element 40A and the first top arc-shaped groove 211A of each corner 21 form a first top circular groove 212A, and the second top arc-shaped groove 41B of each first corner complete element 40A and the second top arc-shaped groove 211B of each corner 21 form a second top a circular groove 212B, the first bottom arc-shaped groove 42A of each first corner complete element 40A and the first bottom arc-shaped groove 213A of each corner 21 form a first bottom circular groove 214A, and each second bottom arc-shaped groove 42B of the first corner complete element 40A and the second bottom arc-shaped groove 213B of each corner 21 form a second bottom circular groove 214B.

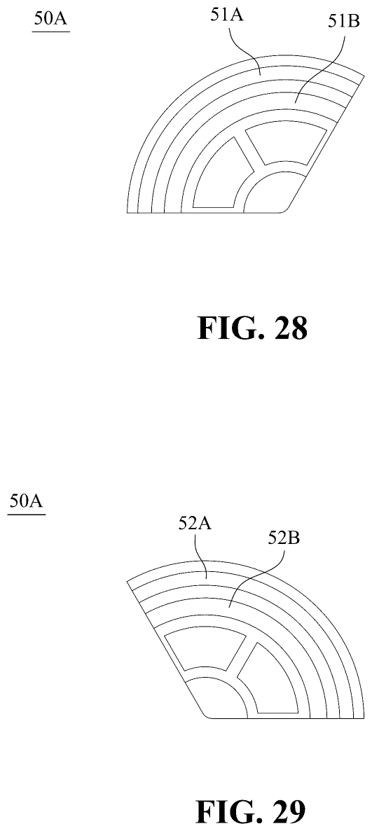

As shown in FIGS. 27, 28 and 29, the difference between the second corner complete element 50A and the second corner complete element 50 is that: first, the top of each second corner complete element 50A forms a first top arc-shaped groove 51A and a second top arc-shaped groove 51B, the first top arc-shaped groove 51A of each second corner complete element 50A is located on outer side the second top arc-shaped groove 51B of each second corner complete element 50A, the arc length of the first top arc-shaped groove 51A of each second corner complete element 50A is one-third of the circumference of a circle, and the arc length of the second top arc-shaped groove 51B of each second corner complete element 50A is one-third of the circumference of ta circle; second, the bottom of each second corner complete element 50A forms a first bottom arc-shaped groove 52A and a second bottom arc-shaped groove 52B; the first bottom arc-shaped groove 52A of each second corner complete element 50A is located on outer side of the second bottom arc-shaped groove 52B of each second corner complete element 50A, the arc length of the first bottom arc-shaped groove 52A of each second corner complete element 50A is one-third of the circumference of a circle, and the arc length of the second bottom arc-shaped groove 52B of each second corner complete element 50A is one-third of the circumference of a circle. As shown in FIGS. 18, 19 and 20, when each second corner complete element 50A is butted with the two corners 21, the first top arc-shaped groove 51A of each second corner complete element 50A and the first top arc-shaped grooves 211A of the two corners 21 form a first top circular groove 212A, the second top arc-shaped grooves 51B of each second corner complete element 50A and the second top arc-shaped grooves 211B of the two corners 21 form a second top circular groove 212B, the first bottom arc-shaped groove 52A of each second corner complete element 50A and the first bottom arc-shaped grooves 213A of the two corners 21 form a first bottom circular groove 214A, and the second bottom arc-shaped groove 52B of each second corner complete element 50A and the second bottom arc-shaped grooves 213B of the two corners 21 form a second bottom circular groove 214B.

As shown in FIGS. 18, 19 and 20, the convex rings 61 of the covers 60 are respectively inserted into the second top circular grooves 212B.

As shown in FIGS. 18, 19 and 20, the diameter of each first column 70A is smaller than the diameter of each second column 70B, and the first ends of the first columns 70A are respectively inserted into the second bottom circular grooves 214B of the top bracket device 200A, and the second ends of the first columns 70A are respectively inserted into the second top circular grooves 212B of the middle bracket device 400. The first ends of the second columns 70B are respectively inserted into the first bottom circular grooves 214A of the middle bracket device 400, and the second ends of the second columns 50B are respectively inserted into the first top circular grooves 212A of the bottom bracket device 300A.

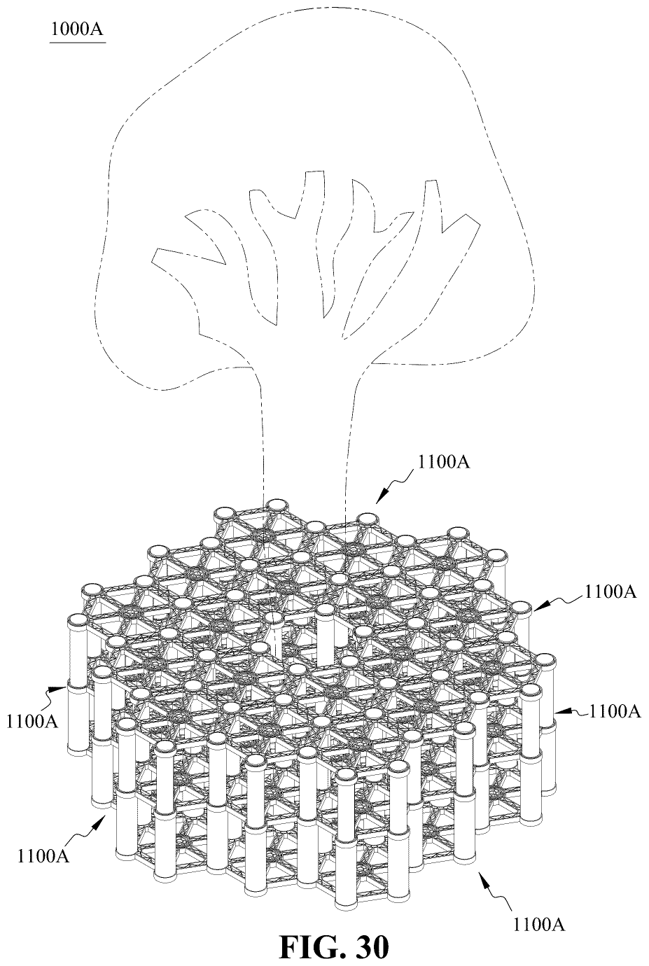

As shown in FIG. 30, the plurality of top bracket devices 200A are arranged around the same plane and jointly form a first center hole. The plurality of middle bracket devices 400 are arranged around the same plane and jointly form a third center hole. The plurality of bottom bracket devices 300A are arranged around the same plane and jointly form a second center hole. The first center hole, the second center hole and the third center hole are aligned and used for a root ball to pass through.

Specifically, during construction, a tree pit is dug in the tree planting area, the adjacent driveway or the hard pavement, and the second embodiment of the bracket system 1000A is installed in the tree pit. A drainage system (not shown) can be installed in the space formed by the hexagonal bracket elements 1A, and a root ball is planted in the first center hole, the second center hole and the third center hole formed by the bracket devices, then backfilling the soil into the tree pits, and finally covering up the surface of the planting area to restore hard pavement for people and vehicles to pass.

Compared to three bracket devices 100 and the first embodiment of the bracket system 1000, the second embodiment of the bracket system 1000A, through the serial connection with support of first columns 70A and the second columns 70B, provides stronger overall structural strength and support the soil better.

Furthermore, through the serial connection and support of the first columns 70A and the second columns 70B, the second embodiment of the bracket system 1000A can create a deeper and wider tree cavity, and can provide a deeper and wider room for the tree root system to grow.

In addition, the soil below requires stronger supporting force, so the second column 50B with a larger diameter is required to further strengthen the overall structural strength of the second embodiment of the bracket system 1000A, and the effect of supporting the soil is even better.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A bracket device for tree pit root management, comprising:
at least three hexagonal bracket elements, wherein each hexagonal bracket element comprises a center bracket, six side brackets, and six connecting brackets; a corner is formed between two adjacent side brackets, and an arc-shaped groove is formed at the top of each corner; the arc length of the top arc-shaped groove is one-third of the circumference of a circle; the connecting brackets connect the center bracket and the side brackets respectively; when three corners of the hexagonal bracket elements are connected, the top arc-shaped grooves of the three corners are connected to form a top circular groove; and
a cover, comprising a convex ring, and the convex ring being inserted into the top circular groove to fortify the strength.

2. The bracket device for tree pit root management according to claim 1, further comprising a plurality of first corner complete elements, a plurality of a second corner complete elements, and a plurality of covers, wherein a top arc-shaped groove is formed on the top of each first corner complete element, and the arc length of the top arc-shaped groove of each first corner complete element is two-thirds of the circumference of a circle; when each first corner complete element butts with each corner, the top arc-shaped groove of each first corner complete element and the top arc-shaped groove of each corner form a top circular groove; wherein a top arc-shaped groove is formed on the top of each second corner complete element and the arc length of the top arc-shaped groove of each second corner complete element is one-third of the circumference of a circle; wherein when each second corner complete element butts with the two corners, the top arc-shaped groove of each second corner complete element and the top arc-shaped groove of the two corners form a top circular groove; wherein the convex rings of the covers are inserted into the top circular groove to fortify the strength.

3. The bracket device for tree pit root management according to claim 2, wherein at least three bracket devices are arranged around the same plane and jointly form a central hole, and the central hole is used for a root ball to pass through.

4. The bracket device for tree pit root management according to claim 2, wherein each first corner complete element is a two-thirds circular structure, and each second corner complete element is a one-third circular structure.

5. The bracket device for tree pit root management according to claim 1, wherein at least three bracket devices are arranged around the same plane and jointly form a center hole, and the central hole is used for a root ball to pass through.

6. The bracket device for tree pit root management according to claim 1, wherein a bottom arc-shaped groove is formed at the bottom of each corner, and the arc length of the bottom arc-shaped groove of each corner is one-third of the circumference of a circle; wherein when the three corners of the hexagonal bracket elements are butted together, the bottom arc-shaped grooves of the corners form a bottom circular groove; wherein two bracket devices and a column form a first bracket module, and the plurality of bracket devices are respectively defined as an top bracket device and a bottom bracket device, a first end of the column is inserted into the bottom circular groove of the top bracket device, and a second end of the column is inserted into the top circular groove of the bottom bracket device, and a plurality of first bracket modules form a bracket system.

7. The bracket device for tree pit root management according to claim 6, further comprising a plurality of first corner complete elements, a plurality of a second corner complete elements, a plurality of covers and a plurality of columns, wherein a top arc-shaped groove is formed on the top of each first corner complete element, and the arc length of the top arc-shaped groove of each first corner complete element is two-thirds of the circumference of a circle; a bottom arc-shaped groove is formed at the bottom of each first corner complete element, and the arc length of the bottom arc-shaped groove of each first corner complete element is two-thirds of the circumference; wherein when each first corner complete element butts with each corner, the top arc-shaped groove of each first corner complete element and the top arc-shaped groove of each corner form a top circular groove, and the bottom arc-shaped groove of each first corner complete element and the bottom arc-shaped groove of each corner form a bottom circular groove; wherein a top arc-shaped groove is formed on the top of each second corner complete element and the arc length of the top arc-shaped groove of each second corner complete element is one-third of the circumference of a circle; a bottom arc-shaped groove is formed at the bottom of each second corner complete element, and the arc length of the bottom arc-shaped groove of each second corner complete element is two-thirds of the circumference of a circle; wherein when each second corner complete element butts with the two corners, the top arc-shaped groove of each second corner complete element and the top arc-shaped groove of the two corners form a top circular groove; wherein the convex rings of the covers are inserted into the top circular grooves respectively; wherein first ends of the columns are inserted into the bottom circular grooves of the top bracket devices, and second ends of the columns are inserted into the top circular grooves of the bottom bracket devices, respectively.

8. The bracket device for tree pit root management according to claim 7, wherein the three top bracket devices are arranged around the same plane and jointly form a first center hole; the three bottom bracket devices are arranged around the same plane and jointly form a second center hole; the first center hole and the second center hole are aligned and are used for a root ball to pass through.

9. The bracket device for tree pit root management according to claim 7, wherein each first corner complete element is a two-thirds circular structure, and each second corner complete element is a one-third circular structure.

10. The bracket device for tree pit root management according to claim 6, wherein at least three top bracket devices are arranged around the same plane and jointly form a first central hole, and at least three bottom bracket devices are arranged around the same plane and jointly form a second central hole; the first central hole is aligned with the second central hole and are jointly used for a root ball to pass through.

11. The bracket device for tree pit root management according to claim 1, wherein a first top arc-shaped groove and a second top arc-shaped groove are formed on the top of each corner, and the first top arc-shaped groove of each corner is located on outer side of the second top arc-shaped groove of each corner; the arc length of the first top arc-shaped groove at each corner is one-third of the circumference of a circle, and the arc length of the second top-arc groove at each corner is one-third of the circumference of a circle; wherein, a first bottom arc-shaped groove and a second bottom arc-shaped groove are formed at the bottom of each corner, and the first bottom arc-shaped groove of each corner is located on outer side of the second bottom arc-shaped groove of each corner; the arc length of the first bottom arc-shaped groove of each corner is one-third of the circumference of a circle, and the arc length of the second bottom arc-shaped groove at each corner is one-third of the circumference of a circle; wherein when the three corners of the hexagonal bracket elements are butted together, the first top arc-shaped grooves at the corners form a first top circular groove, the second top arc-shaped grooves at the corners form a second top circular groove, the first bottom arc-shaped grooves at the corners form a first bottom circular groove, and the second bottom arc-shaped grooves at the corners form a second bottom circular groove; wherein the convex rings of the covers are respectively inserted into the first top circular grooves; wherein three bracket devices, a first column and a second column form a second bracket module, the plurality of bracket devices are respectively defined as a top bracket device, a middle bracket device, and a bottom bracket device; a first end of the first column is inserted into the first bottom circular groove or the second bottom circular groove of the top bracket device, a second end of the first column is inserted into the first top circular groove or the second top circular groove of the middle bracket device, and a first end of the second column is inserted into the first bottom circular groove or the second bottom circular groove of the middle bracket device, and a second end of the second column is inserted into the first top circular groove or the second top circular groove of the bottom bracket device, and a plurality of second bracket modules form a bracket system.

12. The bracket device for tree pit root management according to claim 11, further comprising a plurality of first corner complete elements, a plurality of second corner complete elements, a plurality of covers, a plurality of first columns, and a plurality of second columns;
wherein a first top arc-shaped groove and a second top arc-shaped groove are formed on the top of each first corner complete element, and the first top arc-shaped groove of each first corner complete element is located on outer side of the second top arc-shaped groove of each first corner complete element, the arc length of the first top arc-shaped groove of each first corner complete element is two-thirds of the circumference of a circle, and the arc length of the second top arc-shaped groove of each first corner complete element is two-thirds of the circumference of a circle; a first bottom arc-shaped groove and a second bottom arc-shaped groove are formed on the bottom of each first corner complete element, the first bottom arc-shaped groove of each first corner complete element is located on outer side of the second bottom arc-shaped groove of each first corner complete element, the arc length of the first bottom arc-shaped groove of the first corner complete element is two-thirds of the circumference of a circle, and the arc length of the second bottom arc-shaped groove of each first corner complete elements is two-thirds of the circumference of a circle; wherein when each first corner complete element is butted with each corner, the first top arc-shaped groove of each first corner complete element and the first top arc-shaped groove of each corner form a first top circular groove, the second top arc-shaped groove of each first corner complete element and the second top arc-shaped groove of each corner form a second top circular groove, the first bottom arc-shaped groove of each first corner complete element and the first bottom arc-shaped groove of each corner form a first bottom circular groove, and the second bottom arc-shaped groove of each first corner complete element and the second bottom arc-shaped groove of each corner form a second bottom circular groove; wherein a first top arc-shaped groove and a second top arc-shaped groove are formed on the top of each second corner complete element, the first top arc-shaped groove of the second corner complete element is located on outer side of the second top arc-shaped groove of each second corner complete element, the arc length of the first top arc-shaped groove of the second corner complete element is one-third of the circumference of a circle, the arc length of the second top arc-shaped groove of each second corner complete element is one-third of the circumference of a circle; a first bottom arc-shaped groove and a second bottom arc-shaped groove are formed on the bottom of each second corner complete element, the first bottom arc-shaped groove of each second corner complete element is located on outer side of the second bottom arc-shaped groove of each second corner complete element, the arc length of the first bottom arc-shaped groove of each second corner complete element is one-third of the circumference of a circle, and the arc length of the second bottom arc-shaped groove of each second corner complete element is one-third of the circumference of a circle; wherein when each second corner complete element is butted with two corners, the first top arc-shaped groove of each second corner complete element and the first top arc-shaped grooves of the two corners form a first top circular groove, the second top arc-shaped groove of each second corner complete element and the second top arc-shaped grooves of the two corners form a second top circular groove, the first bottom arc-shaped groove of each second corner complete element and the first bottom arc-shaped grooves of the two corners form a first bottom circular groove, and the second bottom arc-shaped groove of each second corner complete element and the second bottom arc-shaped grooves of the two corners form a second bottom circular groove;
wherein, the convex rings of the covers are respectively inserted into the second top circular grooves; wherein, the first ends of the first columns are respectively inserted into the first bottom circular groove or the second bottom circular groove of the top bracket device, and the second ends of the first columns are respectively inserted into the first top circular grooves or the second top circular grooves of the middle bracket device; the first ends of the second columns are respectively inserted into the first bottom circular groove or second bottom circular groove of the middle bracket device, and the second ends of the second columns are respectively inserted into the first top circular groove or the second top circular groove of the bottom bracket device.

13. The bracket device for tree pit root management according to claim 12, wherein the three top bracket devices are arranged around the same plane and jointly form a first center hole; the three middle bracket devices are arranged around the same plane and jointly form a third center hole; the three bottom bracket devices are arranged around the same plane and jointly form a second center hole; and, the first center hole, the second center hole and the third center hole are aligned and used for a root ball to pass through.

14. The bracket device for tree pit root management according to claim 12, wherein each first corner complete element has a two-thirds circular structure, and each second corner complete element has a one-third circular structure.

15. The bracket device for tree pit root system management according to claim 11, wherein at least three bracket devices are arranged around the same plane and jointly form a first central hole, at least three middle bracket devices are arranged around the same plane and jointly form a third central hole, at least three bottom bracket devices are arranged around the same plane and jointly form a second central hole, and the first central hole and the second central hole are aligned with the third central hole and used together for a root ball to pass through.
